(19) United States
(12) Patent Application Publication
(10) Pub. No.: US 2007/0265931 A1
(43) Pub. Date: Nov. 15, 2007

(54) Method of forming and using referral networks via the Internet

(76) Inventor: David Ray Burritt, Broomfiel, CO (US)

Correspondence Address: David Burritt, 1350 Bellaire, Broomfield, CO, 80020, US

(21) Appl. No.: 11/430,565

(22) Filed: May 9, 2006

(51) Int. Cl. G06Q 30/00

(52) U.S. Cl. 705/26

(57) ABSTRACT

This invention describes a method were people who use the Internet to provide any service (e.g., rent out their vacation home) can partner with other people who do the same and form an network where they can refer customers to each other. This patent application is mainly targeted for rental properties being managed by individual owners but it could also apply to any piece of property(s) being rented or managed over the Internet.

### TECHNICAL FIELD

This invention relates to how multiple people who provide a similar service via the Internet can use a referral network to increase their sales.

### CROSS REFERENCE TO RELATED APPLICATIONS

None

### FEDERALLY SPONSORED RESEARCH OR DEVELOPMENT

None

### BACKGROUND OF THE INVENTION

Within this document, the following terms shall be used:

Browser: A program which runs on a user's computer and connects to a Web Server (via the Internet). The purpose of a browser is to allow a user to easily get information from the Internet. Microsoft's “Internet Explorer” computer program is an example of a Browser.

Web Server: A computer designed for returning web pages to a user's browser.

Database: A mechanism for storing, modifying, and retrieving data.

Site: Same as Web Server

Calendar: In this document, the term calendar shall be used as a mechanism for getting what dates a piece of rental property is available for rent. The actual format of how the database is stored does not affect this invention. For example, it may be stored in a Sql, MySql, or Oracle database. It may also be stored as a single or series of web pages.

Entity: An entity can be an individual, a company, or a group of individuals who provide a service that they advertise or provide via the Internet. An example of an entity could be a person who owns a vacation rental property in Keystone Colo. and advertises that property for rent via the Internet.

Referral Network: A referral network is a group (2 or more) of entities who provide a similar service and have agreed to send customers to each other when they have a customer that they cannot provide a service for. For example, a referral network might be a group of condo owners in Keystone Colo. These condo owners rent out their property for people wanting to vacation in Keystone. Typically, all these owners advertise their units on the Internet. An owner may get a request for their condo on a particular date. However, they may not have availability and therefore would like to refer the customer to other owners in their referral network.

Within the prior art, it is well known how a group of individuals who provide a similar service (entities) may contact each other and use email or the telephone to refer customers to each other. However, if more than a couple of individuals are involved and more than a couple of referrals are generated then the individuals are presented with the following problems:
1. For the entity who is generating the referral it needs to contact all the other entities (typically, but not required, via email). As entities join and leave this “referral network” all the entities in the referral network must keep their email list up to date.
2. The entity that is generating the referral must manually generate the email and send it to all the other entities in the referral network.
3. If the referring entity only wants to send a referral to entities whose service is available, then it must contact all the other entities in the referral network to find out what their availability is or if they have a suitable service. For example, in the case of rental property, they may want to check their availability calendar or look at the number of bedrooms their property has. This can be a very time consuming task.
4. The referring entity then sends an email to let the other entity know about the customer.
5. The referring entity may also want to notify the customer about all the other entities in the referring entity's network so that the customer may also contact the other entities in the network. This task can also be very time consuming for the referring entity.
6. The entities that get the referral typically must respond to the potential customer in a very timely manner. This requires almost constant contact with their email.
7. If the referring entity did not screen the potential customer then the entity receiving the referral must do it. This can be very time consuming. For example, in the case of vacation rental property, the entity who received the referral must check their availability calendar and also verify that their property matches the needs of the customer.

### SUMMARY OF THE INVENTION

The aforementioned problems are solved and a technical advance is achieved in the art by a method that uses a computer program which goes out to a database (or set of databases) to get information (e.g., calendar and number of bedrooms in the case of a vacation rental property) about the other services for the entities in the “referral network”. This computer program has access to information about the services that all the entities have in the referral network. Therefore, the computer program can automatically screen the information and only send a referral to the members in the referral network who have the ability to serve the customer. In addition, the computer program can automatically contact the customer (typically, but not required, via email) letting the customer know which entities in the referral network can meet their needs. In addition, the computer program can automatically notify the entities in the referral network about the potential customer.

### BRIEF DESCRIPTION OF THE DRAWING

FIGS. 1 & 2 illustrates, in block diagram form, an embodiment of the invention.

FIGS. 3 & 4 illustrates, in block diagram form, another embodiment of the invention.

FIGS. 5 & 6 illustrates, in block diagram form, another embodiment of the invention.

FIGS. 7 & 8 illustrates, in block diagram form, another embodiment of the invention.

FIGS. 9 & 10 illustrates, in block diagram form, another embodiment of the invention.

FIGS. 11 & 12 illustrates, in block diagram form, another embodiment of the invention.

### DETAILED DESCRIPTION

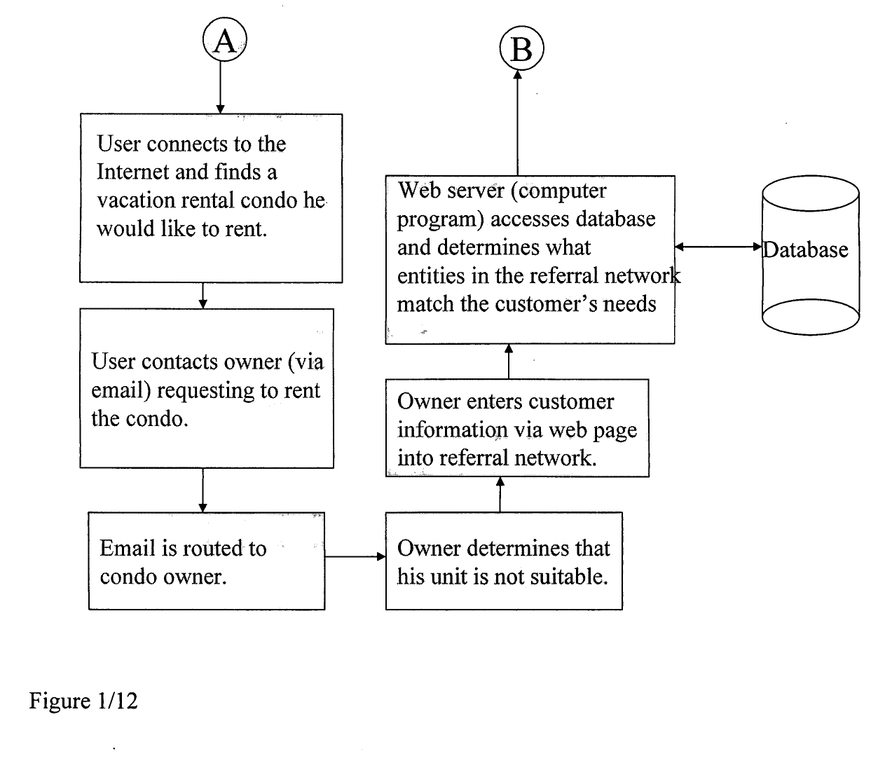

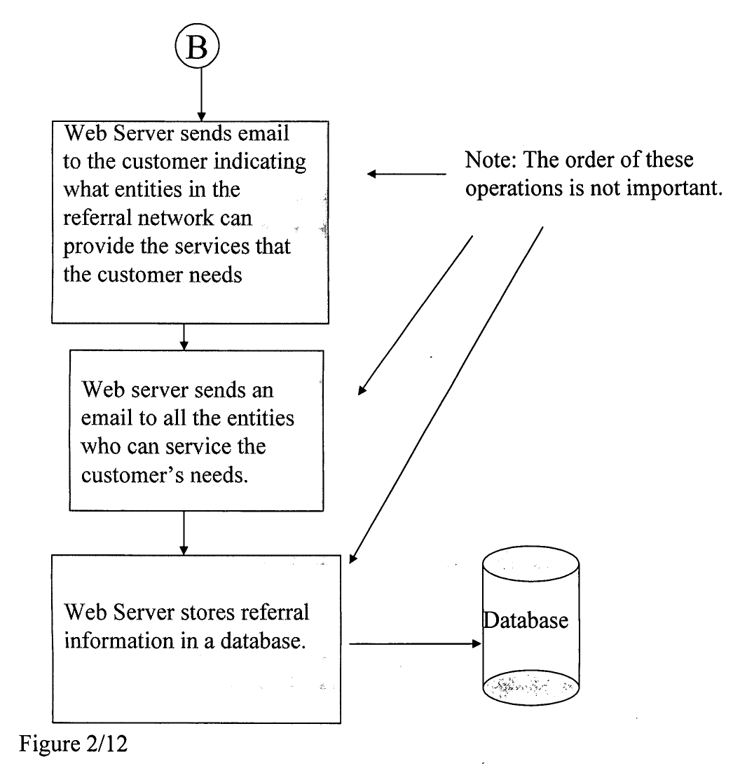

FIGS. 1 & 2 illustrates a sample scenario. In this sample scenario a person is looking for a condo to rent for a vacation he wants to take.

Execution starts at A.

User connects to the Internet

User starts Web Browser and finds a property he wants to rent (e.g., 1 bedroom units in Keystone Colo.). He may find the property via a plurality of mechanisms, including but not limited to general purpose search engines (e.g., Google, AOL, MSN) and/or web sites which specialize in vacation rental properties (e.g., www.rdfo.com, www.vrbo.com, www.cyberrentals.com, etc.).

User contacts owner (via email)

Owner does not have availability so he wants to refer the customer to the other entities in the referral network.

Owner enters pertinent information (e.g., dates the customer wants and number of bedrooms customer needs) into the referral network via a web browser.

The site (Web Server) finds the matching set of properties which match the customer's needs. The web server gets this information by either accessing 1 or more databases or accessing other web pages on the Internet.

The site (Web Server) then sends an email to the potential customer and also to the other members of the referral network indicating a match has been found.

The site also stores the referral information into a database for later retrieval.

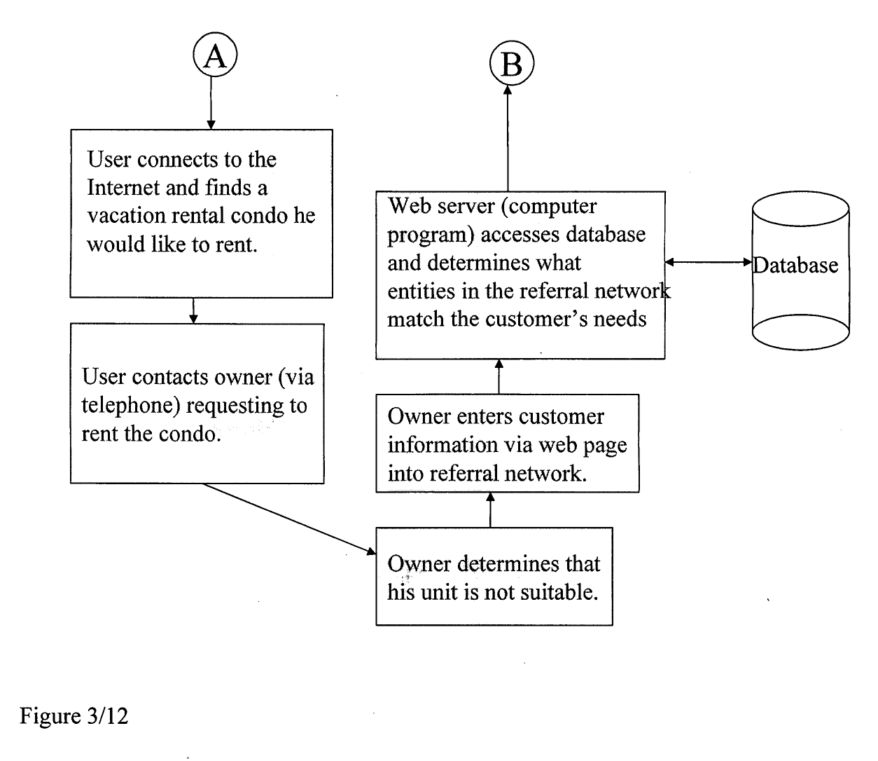

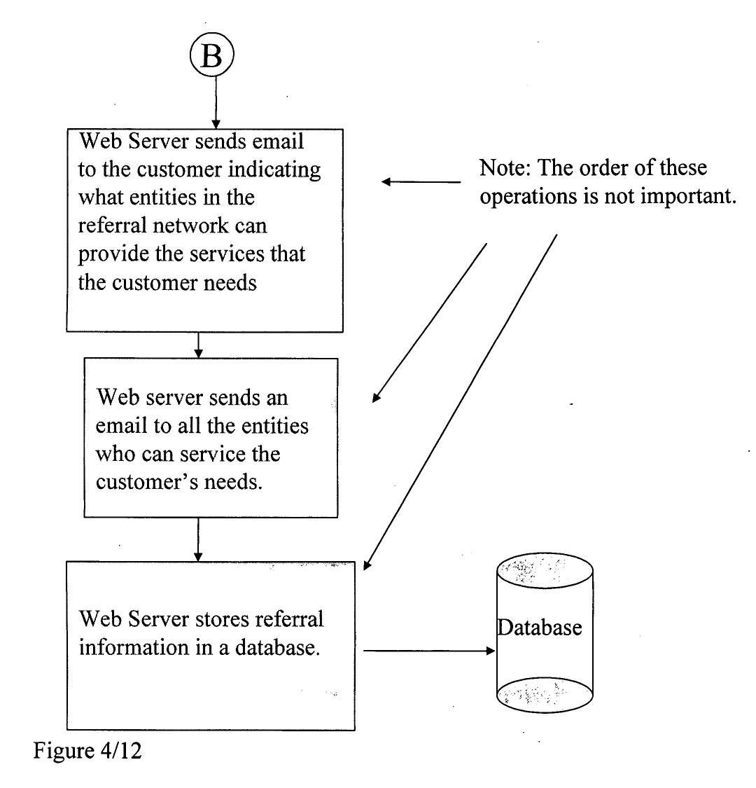

FIGS. 3 & 4 illustrates another sample scenario. In this sample scenario a person is looking for a condo to rent for a vacation he wants to take.

Execution starts at A.

User connects to the Internet

User starts Web Browser and finds a property he wants to rent (e.g., 1 bedroom units in Keystone Colo.). He may find the property via a plurality of mechanisms, including but not limited to general purpose search engines (e.g., Google, AOL, MSN) and/or web sites which specialize in vacation rental properties (e.g., www.rdfo.com, www.vrbo.com, www.cyberrentals.com, etc.).

User contacts owner (via telephone)

Owner does not have availability information.

Owner enters pertinent information (e.g., dates the customer wants and number of bedrooms customer needs) into the referral network via a web browser.

The site (Web Server) finds the matching set of properties which match the customer's needs. The web server gets this information by either accessing 1 or more databases or accessing other web pages on the Internet.

The site (Web Server) then sends an email to the potential customer and also to the other members of the referral network indicating a match has been found.

The site also stores the referral information into a database for later retrieval.

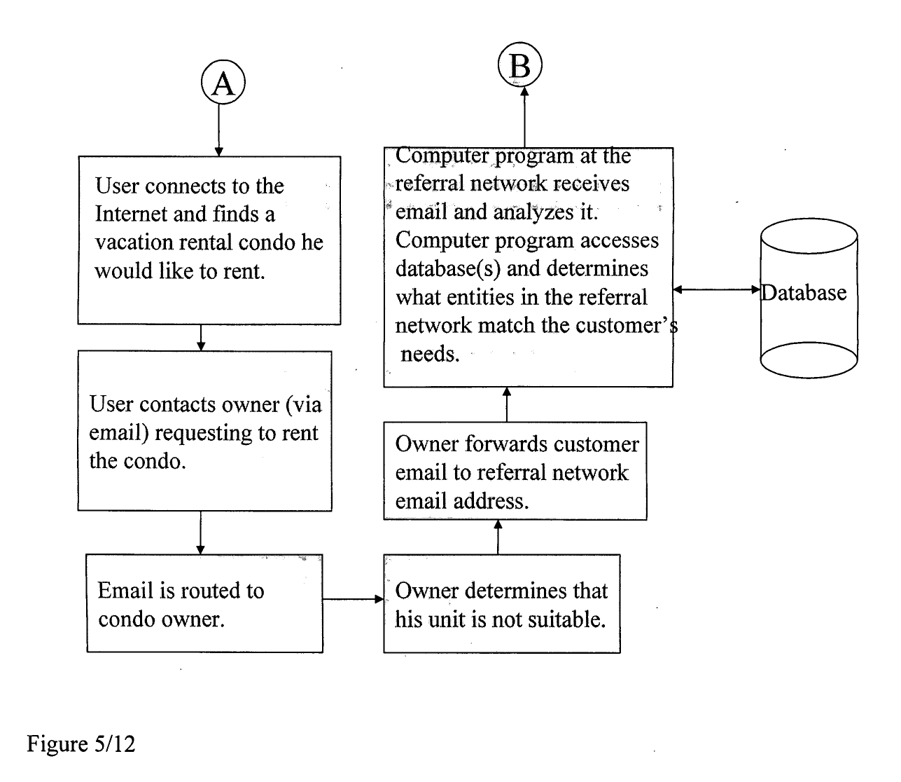

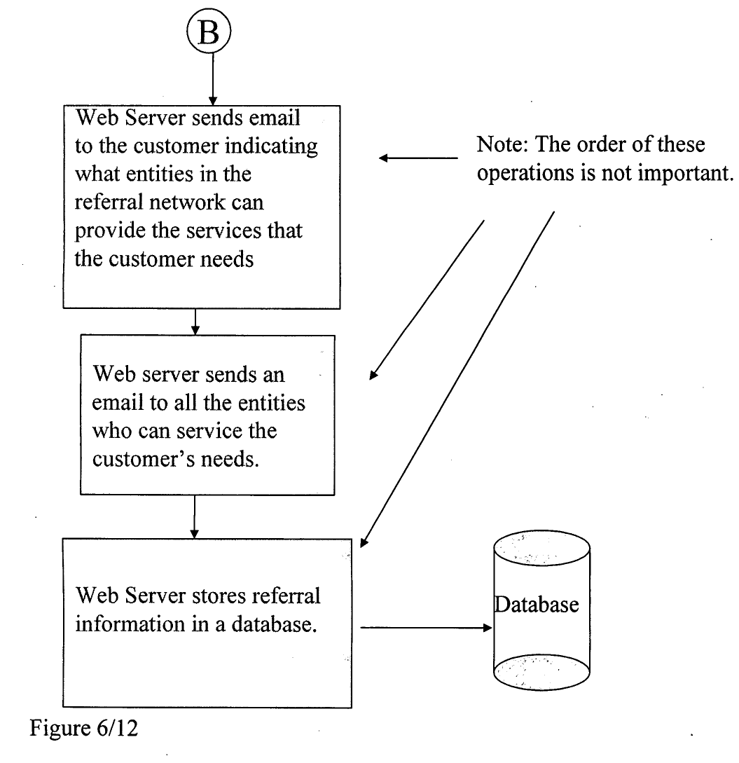

FIGS. 5 & 6 illustrates a sample scenario. In this sample scenario a person is looking for a condo to rent for a vacation he wants to take.

Execution starts at A.

User connects to the Internet

User starts Web Browser and finds a property he wants to rent (e.g., 1 bedroom units in Keystone Colo.). He may find the property via a plurality of mechanisms, including but not limited to general purpose search engines (e.g., Google, AOL, MSN) and/or web sites which specialize in vacation rental properties (e.g., www.rdfo.com, www.vrbo.com, www.cyberrentals.com, etc.).

User contacts owner (via email)

Owner does not have availability information.

Owner forwards email to referral network email address Computer program acting for the referral network automatically analyzes the email and enters pertinent information (e.g., dates the customer wants and number of bedrooms customer needs) into the referral network via a web browser.

The site (Web Server) finds the matching set of properties which match the customer's needs. The web server gets this information by either accessing 1 or more databases or accessing other web pages on the Internet.

The site (Web Server) then sends an email to the potential customer and also to the other members of the referral network indicating a match has been found.

The site also stores the referral information into a database for later retrieval.

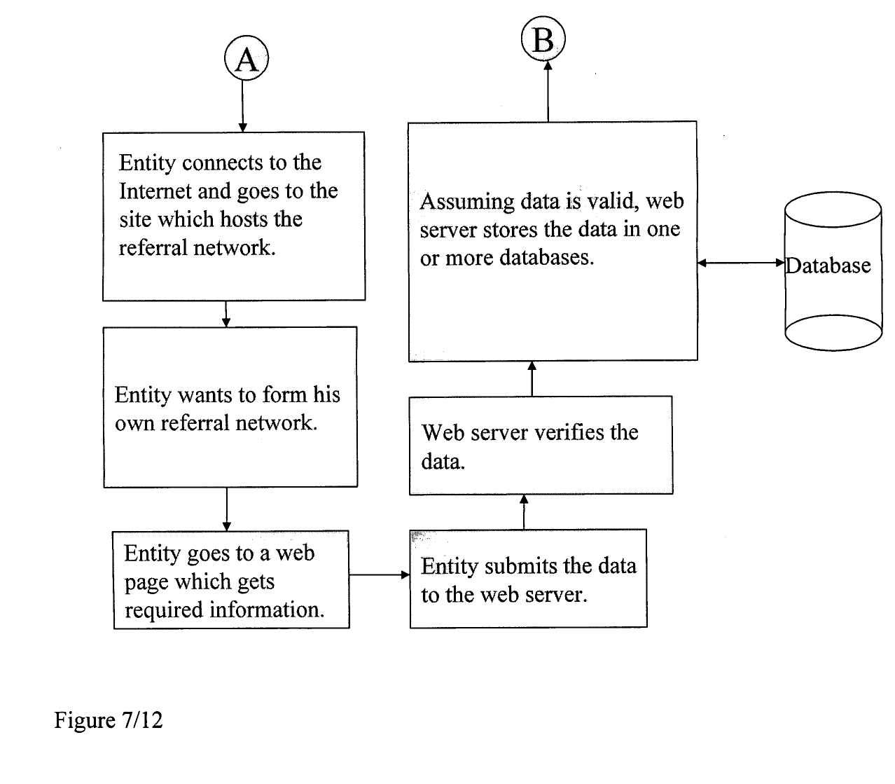

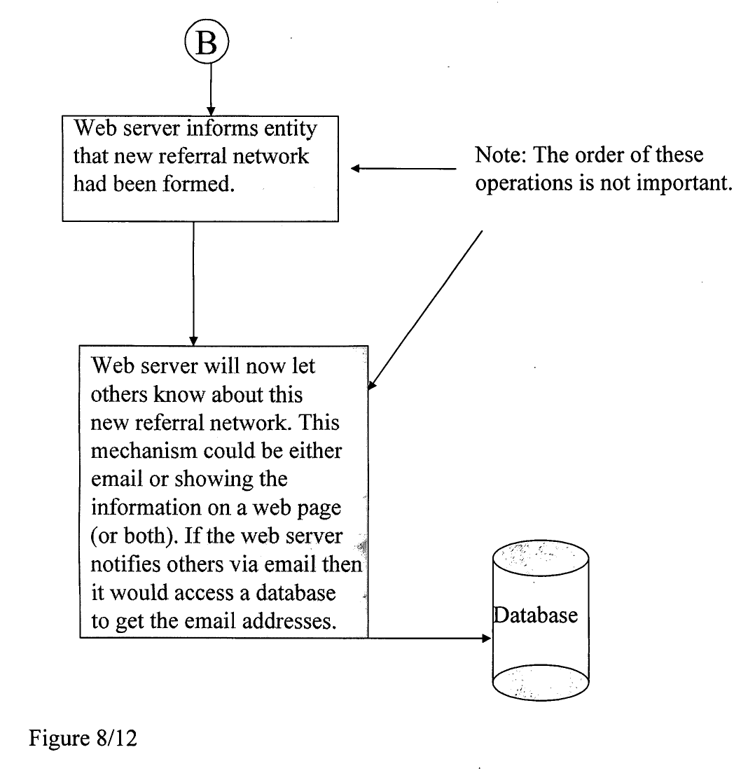

FIGS. 7 & 8 illustrates how an entity could automatically form a referral network.

Execution starts at A.

Entity connects to the Internet

Entity starts Web Browser and goes to a web page which handles the referral network.

Entity goes to a page which handles creating a referral network.

Entity supplies web page with pertinent information about the referral network that it wants to create (name, purpose, etc).

Entity submits information to web server.

Web server verifies the data and then stores the new referral network in a database.

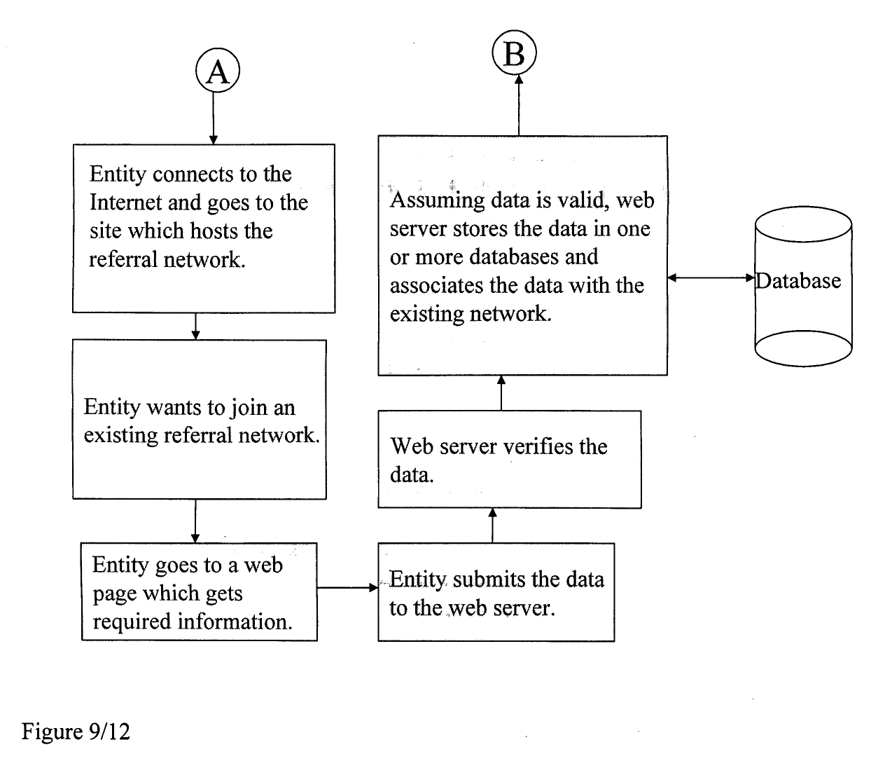

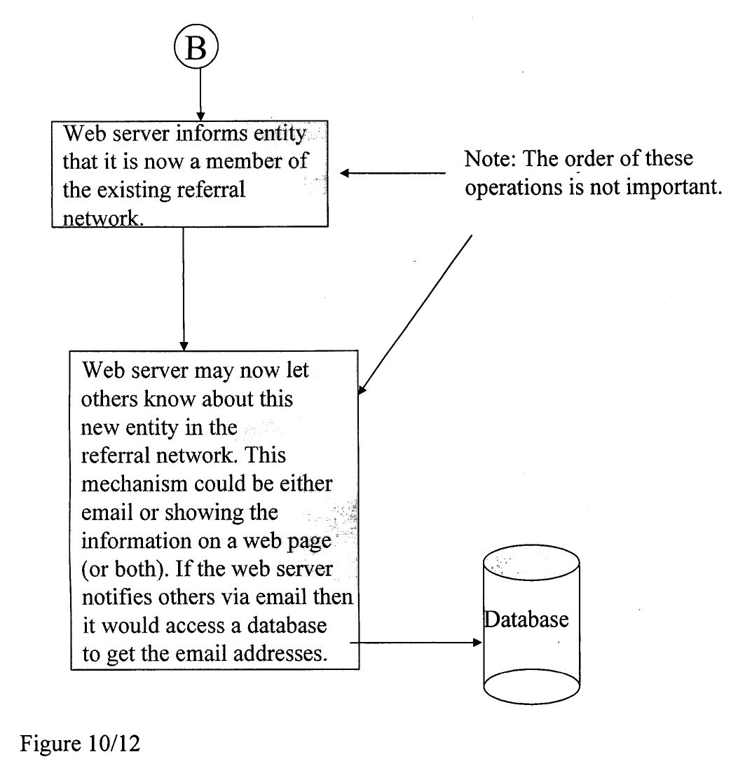

FIGS. 9 & 10 illustrates how an entity could automatically add itself into an existing referral network.

Execution starts at A.

Entity connects to the Internet

Entity starts Web Browser and goes to a web page which handles the referral network.

Entity goes to a page which handles referral network management. Entity supplies web page with pertinent information regarding his

service.

Entity submits information to web server.

Web server verifies the data and then add the new entity to the database(s).

Web server may also email other members of the referral network indicating a new user has added himself.

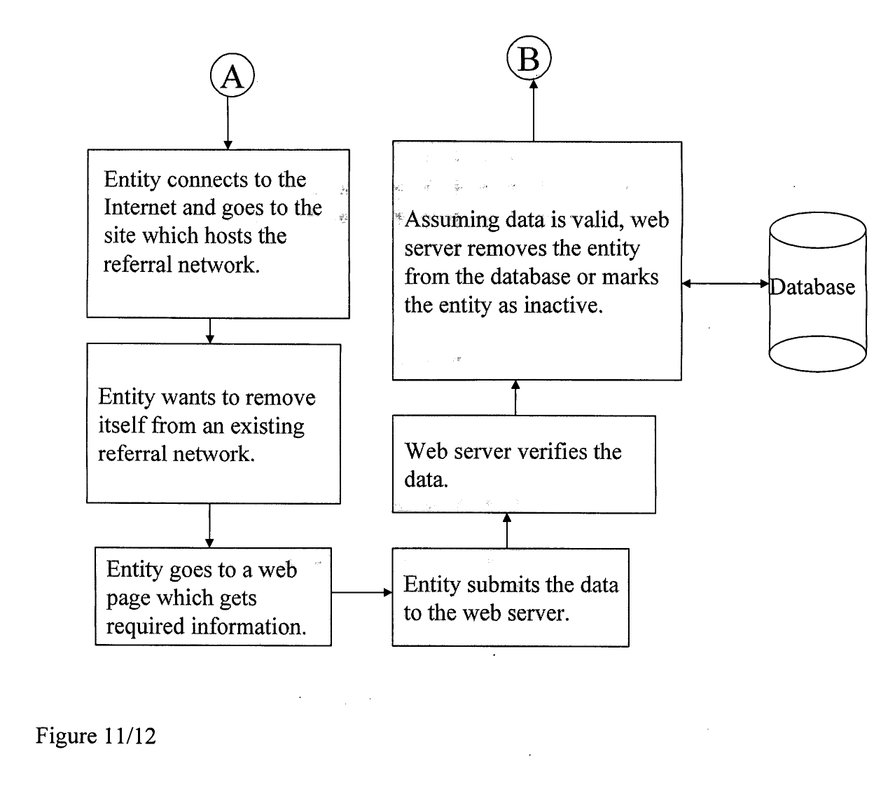

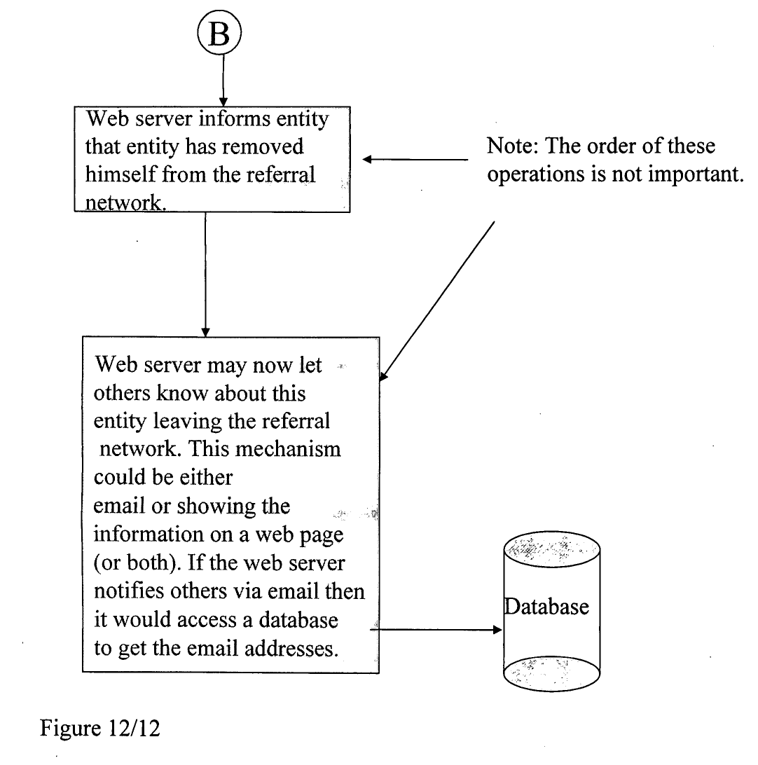

FIGS. 11 & 12 illustrates how an entity could automatically remove itself from a referral network.

Execution starts at A.

Entity connects to the Internet

Entity starts Web Browser and goes to a web page which handles the referral network.

Entity goes to a page which handles referral network management.

Entity supplies web page with pertinent information regarding the removal (e.g., entitity name, password, etc.).

Entity submits information to web server.

Web server verifies the data and then removes (or marks the entity as inactive) from the database(s).

Web server may also email other members of the referral network indicating the user had removed himself.

What is claimed is:

1. A method to show how entities may create a referral network.

2. A method to show how entities may join a referral network.

3. A method to show how entities may leave a referral network.

4. A method to show how entities may communicate to all the other entities in a referral network.

5. A method on how an entity submits a referral into the referral network.

6. A method showing how the computer program processes a referral once it has been put into the referral network.

7. A method showing how the entity can get information about all the referrals that it submitted into the referral network.

8. While this invention mainly pertains to referral networks being used by owners of vacation rental properties it could also apply to any group of entities who perform a service via the Internet. While the invention has been described by means of specific embodiments, numerous modifications and variations could be made thereto by those skilled in the art without departing from the scope and spirit of the invention set forth in the claims. Including, but not limited to, having an approval process that an entity must go through before being allowed to add itself to a referral network or create a referral network.
